(19) United States
(12) Patent Application Publication
(10) Pub. No.: US 2010/0121507 A1
(43) Pub. Date: May 13, 2010

(54) CONTROL DEVICE AND CONTROL METHOD FOR VEHICLE

(75) Inventors: Kenichi Ishii, Nishikamo-gun (JP); Masayuki Komatsu, Aichi-gun (JP); Toshihiro Katsuda, Toyota-shi (JP); Ryouji Oki, Toyota-shi (JP); Tetsuhiro Ishikawa, Nishikamo-gun (JP); Kazuyoshi Ohbayashi, Toyota-shi (JP); Hiroki Sawada, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/450,678

(22) PCT Filed: Apr. 17, 2008
(86) PCT No.: PCT/JP2008/057883

§ 371 Date: Oct. 6, 2009

(30) Foreign Application Priority Data
Apr. 25, 2007 (JP) 2007-115837

(51) Int. Cl. B60L 11/18

(52) U.S. Cl. 701/22

(57) ABSTRACT

A control device has a coupling determination sensor for detecting external connection of a charge table. When the connection of the charge cable is detected according to a signal from the sensor, the control device activates an electric device connected to a communication line of a charge-time-dedicated power supply system. Since the control device of the invention can activate only the electric device related to the charging while keeping electric devices not related to the charging at rest, and therefore prevents wasteful electric power consumption.

### TECHNICAL FIELD

The invention relates to a control device for a vehicle equipped with a power storage device and using at least a rotating electric machine as a drive source, and particularly to a technique that selectively activates an electric device related to charging when an external charging device charges a power storage device.

### BACKGROUND ART

In recent years, attention has been given to hybrid vehicles and electric vehicles against the background of environmental issues. These vehicles are equipped with a power storage device supplying an electric power to an electric drive motor. However, the electric power of the power storage device is limited so that reduction of electric power consumption becomes an important issue in electric devices on the vehicle.

In view of the above issue, Japanese Patent Laying-Open No. 2002-125301 has disclosed an onboard device power saving device for an onboard device of a vehicle that reduces a quantity of electric power consumed by the onboard device as far as possible. This onboard device power saving device is a device for controlling the electric power supplied to the onboard device of the vehicle, and is characterized in that the onboard device power saving device includes electric power supply limiting means for limiting the electric power supplied to the onboard device according to an externally applied control signal.

Since the onboard device power saving device disclosed in the above publication limits the electric power supplied to the onboard device of the vehicle according to the externally applied control signal, it can significantly reduce the electric power wasted on the vehicle. Accordingly, the mileage of the vehicle can be increased. Further, when the onboard device power saving device receives a preset interrupt control signal while the electric power is not being supplied to the onboard device, the onboard device power saving device starts the electric power supply, and also provides a notification of the start of the electric power supply to an onboard device power saving control device arranged in an electric power control center via communication means.

However, the onboard device power saving device disclosed in the foregoing publication suffers from a problem that power consumption of an external charging device or a power storage device mounted on a vehicle cannot be reduced when the power storage device is charged with the external charging device.

When the external charging device performs the charging, the vehicle is at rest, and therefore onboard electric devices that are included in the plurality of electric devices and are not related to the charging are activated together with the electric devices related to the charging in some cases. This situation occurs because a group of the electric devices operating in charging are connected to the same power supply system as a group of the electric devices operating at the start of the vehicle although the former group of electric devices are not necessarily the same as the latter group of electric devices. Therefore, the electric power may be wasted. This may result in increase of a charge time. A power supply device that controls each of powers supplied to the respective electric devices, in which case it may be impossible to ensure a space for mounting the electric devices on the vehicle.

Further, when a plurality of electric devices connected to a communication line corresponding to the same power supply system are configured to operate such that only a part of the electric devices become active, a communication error may occur due to no response of the inactive electric device. For avoiding the occurrence of the communication error, it is necessary to set an error mask for each electric device so that changes in setting may be complicated.

### DISCLOSURE OF THE INVENTION

An object of the invention is to provide a control device and a control method for a vehicle that can ensure a space for mounting, and further can selectively operate electric devices related to charging of a power storage device during the external charging for achieving reduction in power consumption during the external charging and reduction in charge time of the power storage device.

A control device for a vehicle according to an aspect has at least a rotating electric machine as a drive source. The vehicle includes a plurality of electric devices, a power storage device supplying an electric power to the rotating electric machine and the plurality of electric devices, and a connection unit connecting a charge cable of an external charging device charging the power storage device. The control device includes a first control unit transmitting an activation signal corresponding to an activating operation of the vehicle via a first communication line connected to a predetermined first electric device group in the plurality of electric devices and performing activation control on the first electric device group; and a second control unit transmitting an activation signal via a second communication line connected to a predetermined second electric device group, that is included in the plurality of electric devices and related to the charging by the external charging device and performing activation control on the second electric device group.

According to the invention, the second control unit transmits the activation signal via the second communication line and performs the activation control on each electric device in the second electric device group. Thereby, only the electric devices related to the charging can be activated while keeping the electric devices not related to the charging at rest. Therefore, wasting of the electric power can be suppressed. Consequently, it is possible to reduce the electric power consumed in the external charging device or the power storage device and to reduce a charge time required for charging the power storage device by the external charging device. Further, it is not necessary to arrange a power supply device controlling the power supply for each of the electric devices related to the charging so that a space for mounting the electric devices is not restricted. Accordingly, it is possible to provide the control device for the vehicle that ensures a mounting space, selectively operates the electric devices related to the charging of the power storage device when the external charging is performed, and thereby reduces the power consumption during the external charging and the charge time of the power storage device.

Preferably, the control device further includes a detecting unit detecting a position change of a member operated in charging by the external charging device. The second control member performs the activation control on the second electric device group when the position change of the member is detected.

According to this invention, when the position change of the member operated in charging by the external charging device is detected (e.g., when connection of the charge cable to the connection unit is detected), the activation signal is transmitted via the second communication line to perform the activation control on each electric device in the second electric device group. Thereby, only the electric devices related to the charging can be activated while keeping the electric devices not related to the charging at rest. Therefore, wasting of the electric power can be suppressed. Consequently, it is possible to reduce the electric power consumed in the external charging device or the power storage device and to reduce a charge time required for charging the power storage device by the external charging device. Further, it is not necessary to arrange a power supply device controlling the power supply for each of the electric devices related to the charging so that a space for mounting the electric devices is not restricted.

Further preferably, the detecting unit detects the connection of the charge cable to the connection unit.

According to this invention, when the connection of the charge cable to the connection unit is detected, the activation signal is transmitted via the second communication line to perform the activation control on each electric device in the second electric device group. Thereby, only the electric devices related to the charging can be activated while keeping the electric devices not related to the charging at rest.

Further preferably, the second electric device group includes an electric device connected to the first and second communication lines. The electric device is activated based on at least one of the activation signals transmitted via respective first and second communication lines.

According to this invention, the electric device is activated based on at least one of the activation signals transmitted via respective first and second communication lines. Thereby, the electric device can be activated in response to the connection of the charge cable to the connection unit or the activation operation of the vehicle.

Further preferably, the second electric device group includes first and second electric devices. The local communication line connects the first and second electric devices together.

According to this invention, the local communication line connects the first and second electric devices together. When the charge cable is connected to the connection unit to activate the second electric device group, both the first and second electric devices are activated so that it is possible to, suppress the occurrence of the communication error due to no response at the time of communication via the local communication line. Further, it is not necessary to set an error mask or the like for avoiding the communication error for each of the electric devices.

Further preferably, the power storage device includes a power storage device on a high voltage side and a power storage device on a low voltage side. The second electric device group includes an electric device operating in connection with the power storage device on the high voltage side. The control device further includes a load control unit controlling the electric device to reduce a load quantity of the electric load during operation of the electric device when the connection of the charge cable is detected.

According to this invention, when the connection of the charge cable is detected, the control device controls the electric device to reduce the load quantity of the electric load during the operation of the electric device. Thereby, it is possible to reduce the power consumption of the external charging device or the power storage device during the external charging.

Further preferably, the second electric device group includes a converter charging the power storage device on the low voltage side with the electric power of the power storage device on the high voltage side. The load control unit controls the converter to lower the output voltage during the charging of the power storage device on the low voltage side by the converter when the connection of the charge cable is detected.

According to the invention, when the connection of the charge cable to the connection unit is detected, the converter is controlled to lower its output voltage. Therefore, it is possible to reduce the power consumption of the resistive load that operates with the power supplied from the converter.

Further preferably, the load control unit controls the electric device to stop a function not related to the charging when the electric device operates.

According to this invention, the load control unit controls the electric device to stop the function not related to the charging when the connection of the charge cable is detected. Thereby, the power consumption of the external charging device or the power storage device can be reduced during the external charging.

Further preferably, the power storage device includes a power storage device on a high voltage side and a power storage device on a low voltage side. The electric devices of the second electric device group operate by receiving the electric power from the power storage device on the low voltage side during the activation control. The control device includes a relay changing collectively a state of power supply from the power storage device on the low voltage side to the second electric device group to one of a supply state and a non-supply state; a position change detecting unit detecting a position change of a member operated in charging by the external charging device; and an activating operation detecting unit detecting an activating operation of the vehicle. The control device controls the relay to change the state of power supply to the supply state when at least one of the position change of the member and the activation operation of the vehicle is detected.

According to this invention, the relay can collectively change the states of power supply to the second electric device group to the supply state or the non-supply state. Therefore, as compared with the case where an independent relay of the like is arranged for each electric device, it is possible to suppress the increase in mass. Further, it is possible to prevent deterioration, which may be caused by provision of the plurality of relays, in mountability of other parts on the vehicle. Accordingly, the space for mounting the electric devices can be ensured.

Further preferably, the electric device of the first electric device group operates by receiving the electric power from the power storage device on the low voltage side during the activation control. The control device further includes a relay changing collectively a state of power supply from the power storage device on the low voltage side to the first electric device group to one of a supply state and a non-supply state. The control device controls the relay to change the state of power supply to the supply state when the activation operation of the vehicle is detected.

According to this invention, when the activation operation of the vehicle is detected, the states of power supply to the first and second electric device groups collectively change to the supply state, and the electric devices on the vehicle operates so that the state in which the vehicle can run is attained.

### BRIEF DESCRIPTION OF THE DRAWINGS

FIG. 1 is a block diagram showing a structure of a hybrid vehicle according to a first embodiment of the invention.

FIG. 2 shows a power storage device mounted on the hybrid vehicle.

FIG. 3 is a diagram (first diagram) showing structures of a control device for a vehicle and electric devices connected to the control device according to the first embodiment.

FIG. 4 is a functional block diagram of the control device for the vehicle according to the first embodiment.

FIG. 5 is a flow chart (first flowchart) illustrating a control structure of a program executed by the control device for the vehicle according to the first embodiment.

FIG. 6 is a flowchart (second flowchart) illustrating the control structure of the program executed by the control device for the vehicle according to the first embodiment.

FIG. 7 is a diagram (second diagram) showing structures of the control device for the vehicle and the electric devices connected to the control device according to the first embodiment.

FIG. 8 is a diagram (third diagram) showing structures of the control device for the vehicle and the electric devices connected to the control device according to the first embodiment.

FIG. 9 is a diagram showing structures of a control device for a vehicle and electric devices connected to the control device according to the second embodiment.

FIG. 10 is a functional block diagram of the control device for the vehicle according to the second embodiment.

FIG. 11 is a flowchart (first flowchart) illustrating a control structure of a program executed by the control device for the vehicle according to the second embodiment.

FIG. 12 is a flowchart (second flowchart) showing the control structure of the program executed by the control device for the vehicle according to the second embodiment.

### BEST MODES FOR CARRYING OUT THE INVENTION

Embodiments of the invention will now be described with reference to the drawings. In the following description, the same portions bear the same reference numbers and the same names, and achieve the same functions. Therefore, description thereof is not repeated.

<First Embodiment>

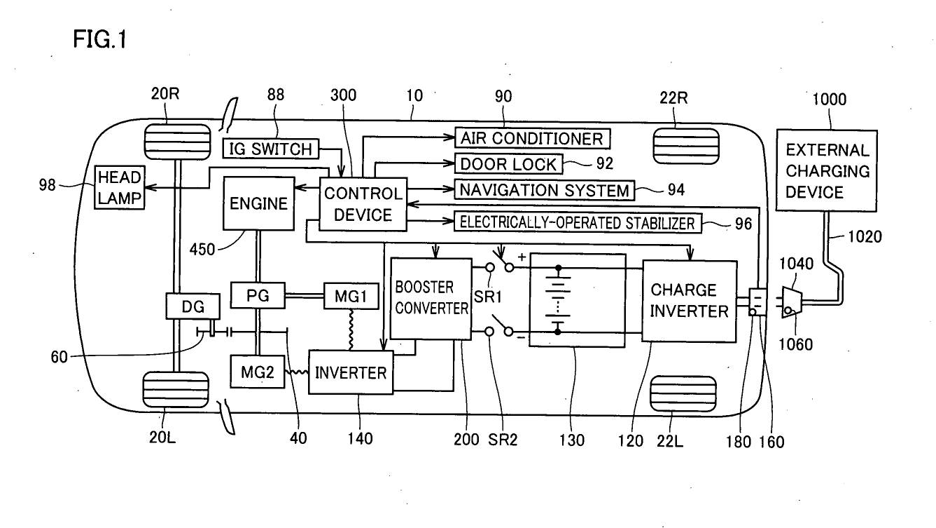

FIG. 1 is a block diagram showing a structure of a hybrid vehicle 10 according to an embodiment of the invention.

Referring to FIG. 1, hybrid vehicle 10 includes front wheels 20R and 20L, rear wheels 22R and 22L, an engine 450, a planetary gear PG, a differential gear DG, and gears 40 and 60.

Hybrid vehicle 10 further includes a battery 130, a booster converter 200 boosting a DC power supplied from battery 130 and an inverter 140 transferring the DC power to or from booster converter 200.

Hybrid vehicle 10 further includes a motor generator MG1 that receives a drive power of engine 450 via planetary gear PG to generate an electric power, and a motor generator MG2 having a rotation axis connected to planetary gear PG. Inverter 140 is connected to motor generators MG1 and MG2 to perform conversion between an AC power and the DC power provided from a booster circuit.

Planetary gear PG includes a sun gear, a ring gear, pinion gears meshing with both the sun and ring gears, and a planetary carrier rotatably carrying the pinion gears around the sun gear. Planetary gear PG has first, second and third rotation axes. The first rotation axis is the rotation axis of the planetary carrier connected to engine 450. The second rotation axis is the rotation axis of the sun gear connected to motor generator MG1. The third rotation axis is the rotation axis of the ring gear connected to motor generator MG2.

The third rotation axis is provided with a gear 40. Gear 40 drives a gear 60 to transmit a mechanical power to differential gear DG, which transmits the mechanical power received from gear 60 to front wheels 20R and 20L, and also transmits the rotation power of front wheels 20R and 20L to the third rotation axis of planetary gear PG via gears 60 and 40.

Planetary gear PG operates to split the power for engine 450 and motor generators MG1 and MG2. More specifically, planetary gear PG determines the rotation of one of the three rotation axes according to the rotations of the other two rotation axes. Therefore, engine 450 is kept to operate in an range of the highest efficiency and, at the same time, motor generator MG2 is driven by controlling a quantity of the electric power generated by motor generator MG1 so that a vehicle speed is controlled, and the vehicle of high energy efficiency is implemented as a whole.

Battery 130 that is a DC power supply is formed of, e.g., a secondary battery such as a nickel hydrogen battery or a lithium ion battery. Battery 130 supplies the DC power to booster converter 200, and is charged with the DC power supplied from booster converter 200.

Booster converter 200 boosts the DC voltage supplied from battery 130, and supplies the boosted DC voltage to inverter 140. Inverter 140 converts the supplied DC voltage to the AC voltage for performing the drive control of motor generator MG1 at the time of engine starting. After the start of the engine, the AC power generated by motor generator MG1 is converted to the DC power, and then is converted by booster converter 200 to attain a voltage that is appropriate for the charging of battery 130. Battery 130 is charged with the power thus converted.

Inverter 140 drives motor generator MG2. Motor generator MG2 assists engine 450 to drive front wheels 20R and 20L. In the braking operation, motor generator MG2 performs a regenerative operation to convert rotation energy of the wheels to electric energy. The electric energy thus obtained returns to battery 130 via inverter 140 and booster converter 200.

Battery 130 is a battery assembly including a plurality of battery units B0-Bn connected in series together. System main relays SR1 and SR2 are arranged between booster converter 200 and battery 130 for interrupting a high voltage when the vehicle is not operating.

Hybrid vehicle 10 further includes an ignition (which may also be referred to as “IG” hereinafter) switch 88 that is an input unit receiving a vehicle start request instruction from a driver, an air conditioner 90, a door lock 92, a navigation system 94, an electrically-operated stabilizer 96, headlamps 98, engine 450, inverter 140, booster converter 200 and a control device 300 controlling these electric devices and units. IG switch 88 may be formed of a push button or a rotary switch, and is not particularly restricted.

Hybrid vehicle 10 further includes a socket 160 that is a connection unit for connecting a plug 1040 arranged at an end of a charge cable 1020 extending from an external charging device 1000, a coupling determination sensor 180 arranged in socket 160 for sensing a coupling determination element 1060 of plug 1040 and thereby recognizing the connection of plug 1040 to socket 1040, and a charge inverter 120 (i.e., an inverter for charging) that receives the AC power from external charging device 1000 via socket 160. Charge inverter 120 is connected to battery 130, and supplies the DC power for charging to battery 130. Coupling determination sensor 180 may be of any type and may be configured, e.g., to detect a magnet on the plug side, to be of a push button type (i.e., to be pushed in when the plug is plugged) or to detect a connection resistance of a power supply path. When plug 1040 is connected to socket 160, coupling determination sensor 180 transmits a plug connection signal to control device 300.

In this embodiment, external charging device 1000 supplies the electric power to battery 130 via charge inverter 120. However, the manner of the external charging is not restricted to this. For example, battery 130 may be charged by supplying the electric power of external charging device 1000 through a neutral point of motor generator MG1 or MG2.

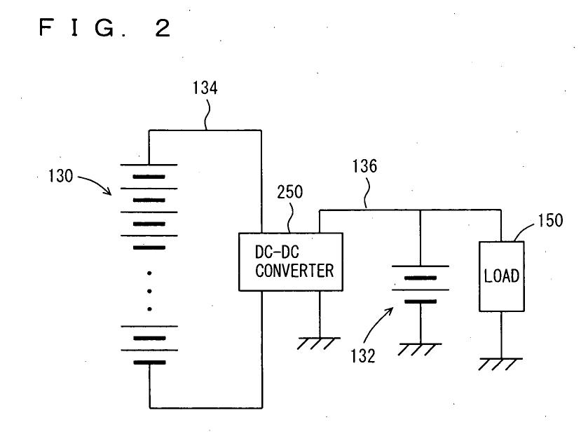

In this embodiment, as shown in FIG. 2, the vehicle is equipped with battery 130 that is the power storage device on a high voltage side as well as a battery 132 that is a power storage device on a low voltage side for supplying an electric power to accessories. Battery 130 is connected to a DC-DC converter 250 via a high-voltage power line 134. Battery 132 is connected to DC-DC converter 250 via a low-voltage power line 136. A load 150 is connected in parallel to DC-DC converter 250 and battery 132.

DC-DC converter 250 receives an input power from battery 130, and outputs a voltage that is set. Battery 132 is charged with the power supplied from DC-DC converter 250, and supplies the power to load 150.

In this embodiment, load 150 is formed of, e.g., air conditioner 90, door lock 92, navigation system 94, electrically-operated stabilizer 96, headlamps 98 and the like, but is not restricted to these electric devices.

Low-voltage power line 136 includes a power supply system of the accessory (which will be referred to as the “ACC” hereinafter) as well as respective power supply systems of IG1, IG2 and PLG.

When the driver operates IG switch 88 to turn on a relay of the ACC, an activation signal is transmitted to the electric devices connected to the power supply system of the ACC, and the power of battery 132 is supplied to the electric devices of the power supply system to activate them. The electric devices of the power supply system of the ACC include, e.g., a radio, an audio device and/or the like, but are not restricted to them.

When the driver operates IG switch 88 to turn on the relays of IG1 and IG2, the activation signals are transmitted to electric devices connected to the power supply systems of IG1 and IG2, respectively. The electric devices of the power supply systems of IG1 and IG2 include, e.g., the electric devices already specified as an example of load 150, but are not restricted to them.

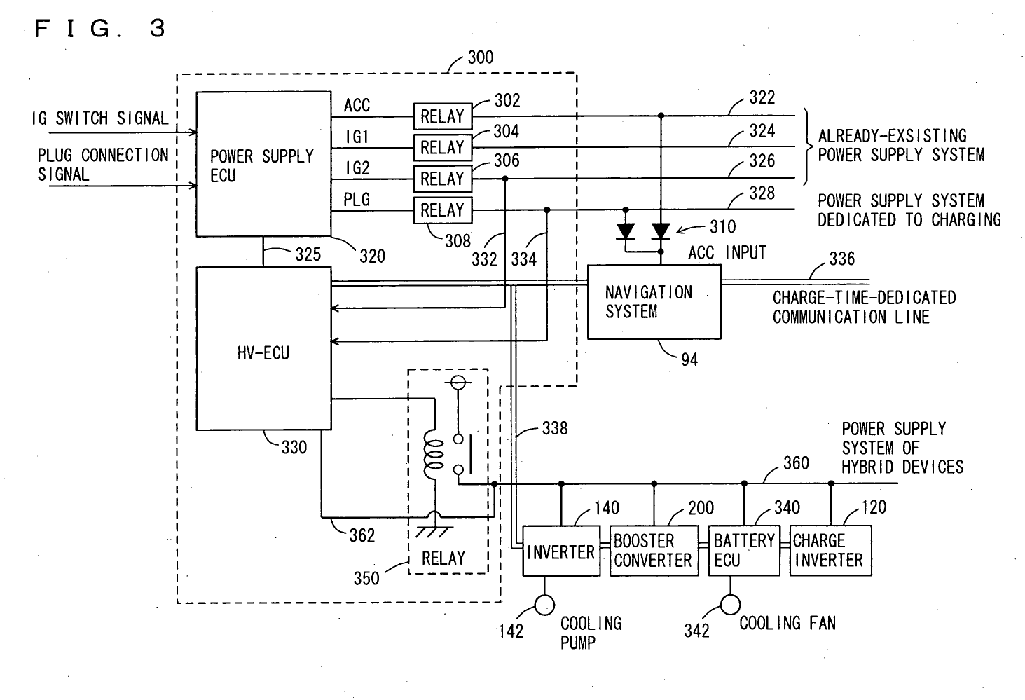

As shown in FIG. 3, control device 300 of the vehicle according to the embodiment includes a power supply ECU (Electronic Control Unit) 320 and an HV-ECU 330. A communication line 325 is connected to power supply ECU 320 and HV-ECU 330. Power supply ECU 320 receives an IG switch signal supplied from IG switch 88, a plug connection signal supplied from coupling determination sensor 180 and a charge determination signal supplied from HV-ECU 330 via communication line 325.

Power supply ECU 320 is connected to relays 302, 304 and 306 corresponding to communication lines 322, 324 and 326 of the power supply systems of the ACC, IG1 and IG2, respectively.

For example, when the driver operates IG switch 88 to perform an operation corresponding to the activation request for the electric devices connected to the power supply system of the ACC, power supply ECU 320 turns on relay 302 in response to an IG switch signal provided from IG switch 88. When relay 302 is turned on, the power is supplied from battery 132 to the electric devices connected to the power supply system of the ACC according to the activation signal transmitted via communication line 322 so that each electric device is activated.

When the driver operates IG switch 88 to perform an operation corresponding to the activation request for the electric devices connected to the power supply systems of IG1 and IG2, power supply ECU 320 turns on relays 304 and 306 in response to the IG switch signal provided from IG switch 88. When relays 304 and 306 are turned on, the electric power of battery 132 is supplied to the electric devices connected to the power supply systems of IG1 and IG2 according to the activation signals transmitted via communication lines 324 and 326 so that these electric devices are activated. In this embodiment, the power supply systems of load 150 include the two power supply systems of IG1 and IG2. However, this is not restrictive, and the power supply system of load 150 may be formed on one power supply system including IG1 and IG2.

Further, power supply ECU 320 is connected to relay 308 corresponding to a communication line 328 of the power supply system of the PLG. The invention has the following distinctive feature. When power supply ECU 320 detects the connection of charge cable 1020 to socket 160 of plug 1040, power supply ECU 320 transmits an activation signal via communication line 328 to the predetermined electric device group related to the charging by external charging device 1000, and thereby controls the activation of the electric device group.

More specifically, when power supply ECU 320 receives the plug connection signal from coupling determination sensor 180, it turns on relay 308. When relay 308 is turned on, the power of battery 132 is supplied to the electric devices connected to the power supply system of the PLG to turn on them according to the activation signal transmitted via communication line 328.

In this embodiment, the electric devices connected to the power supply system of the PLG are HV-ECU 330 and navigation system 94. However, the device may be a device other than navigation system 94 provided that the electric device operates in connection with the charging. For example, it may be an indicator such as LEDs (Light Emitting Diodes) arranged on an install panel for indicating that the charge is being performed.

Navigation system 94 is connected to communication lines 322 and 328 via diodes to form an OR circuit 310, respectively. OR circuit 310 activates navigation system 94 in response to the turn-on of relay 308 or 302.

HV-ECU 330 is connected via a relay 350 to a power supply line 360 of the power supply system of the electric devices that relate to the operations of MG1 and MG2 and will be referred to as the “hybrid devices” hereinafter. HV-ECU 330 is connected to power supply line 360 via a power supply line 362. The hybrid devices include, e.g., inverter 140, booster converter 200, a battery ECU 340 and charge inverter 120, but are not restricted to these electric devices.

Inverter 140 is provided with a cooling pump 142 for circulation in a cooling system cooling inverter 140, and cooling pump 142 operates according to the operation of inverter 140. Battery ECU 340 controls an operation quantity of a cooling fan 342 that supplies a cooling air to battery 130.

HV-ECU 330 is activated by the activation signal from power supply ECU 320 when relay 306 or 308 is turned on. When HV-ECU 330 is activated, relay 350 is turned on. When relay 350 is turned on, the hybrid devices are activated according to activation signals transmitted to the respective hybrid devices. In this operation, the power is supplied to the hybrid devices via power supply line 360, and the power is also supplied to HV-ECU 330 via power supply line 362.

A charge-time-dedicated communication line 336 (i.e., a communication line dedicated to communications during the charging operation) connects HV-ECU 330 to navigation system 94. Further, charge-time-dedicated communication line 336 and a communication line 338 branching from charge-time-dedicated communication line 336 connect HV-ECU 330 to each hybrid device.

For example, during the charging by external charging device 1000, battery ECU 340 or HV-ECU 330 transmits the charge information indicating a state of charge (e.g., SOC (State Of Charge) of battery 130 to navigation system 94 via charge-time-dedicated communication lines 336 and 338: Navigation system 94 displays the state of charge of battery 130 based on the received charge information. Alternatively, navigation system 94 may be configured to display, on its display unit, the state of charge of battery 130 based on a display control signal transmitted via charge-time-dedicated communication lines 336 and 338 from battery ECU 340 or HV-ECU 330.

HV-ECU 330 may be configured to control the hybrid devices to decrease the load quantity of the electric load during the operation of the hybrid devices or to stop the functions unrelated to the charging during the operation of the hybrid devices, when the connection of plug 1040 of charge cable 1020 is detected. In the following description, the above manner of the control will be referred to as the “load control”.

For example, HV-ECU 330 may be configured to reduce as far as possible the operation quantity of cooling pump 142 of the cooling system arranged in inverter 140 or to stop the operation of cooling pump 142 according to the operation state (e.g., temperature of cooling water or the like) thereof. Alternatively, HV-ECU 330 may be configured to reduce as far as possible the operation quantity of cooling fan 342 of battery 130 of which operation quantity is controlled by battery ECU 340, or to stop the operation of cooling fan 342 according to the state of battery 130 (e.g., temperature of battery 130 or the like).

Further, HV-ECU 330 may control the output voltage of DC-DC converter 250 to become lower than the output voltage in the ordinary operation. HV-ECU 330 is merely required to control DC-DC converter 250 such that the output voltage may become lower than the voltage attained in the ordinary operation. For example, when the output voltage of DC-DC converter 250 is 13.5 V in the ordinary operation and HV-ECU 330 detects the connection of plug 1040 of charge cable 1020, DC-DC converter 250 may be controlled to output a predetermined voltage lower than 13.5 V.

In this embodiment, cooling pump 142, cooling fan 342 and DC-DC converter 250 have been described as an example of the form of the load control. However, the electric load is not restricted to them provided that the load control is performed on the electric load that is not related to the charging by external charging device 1000. For example, it is merely required to reduce the operation quantity of the electric load that is not related to the charging or to stop the operation thereof, depending on the manner or type of the charging.

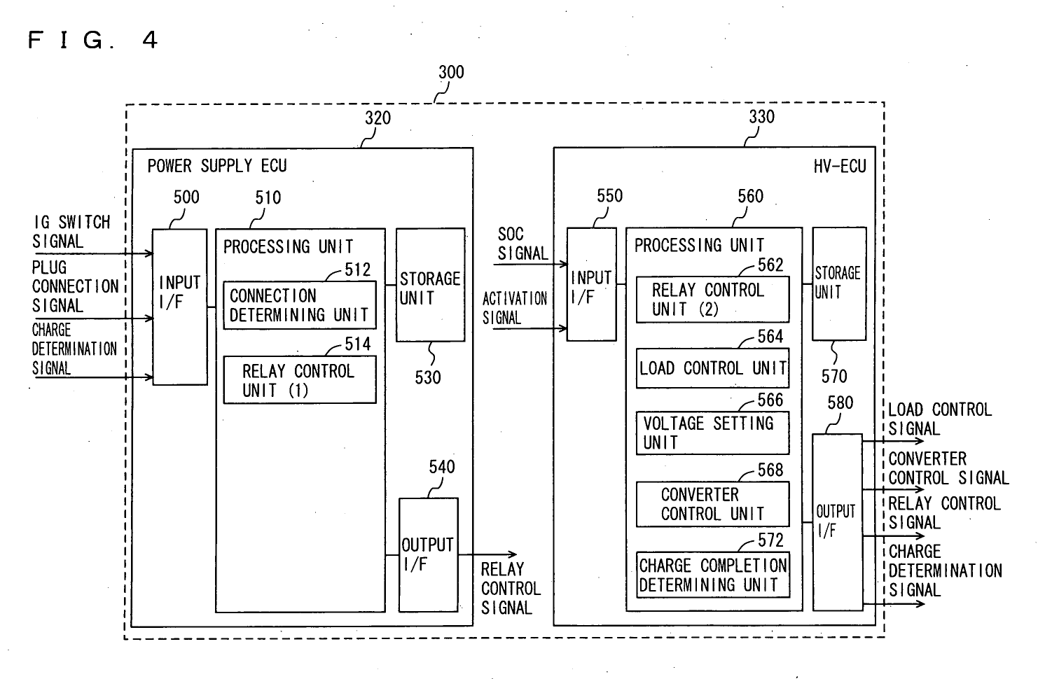

FIG. 4 is a functional block diagram of control device 300 of the vehicle according to the embodiment. Power supply ECU 320 includes an input interface (which will be referred to as an “input I/F” hereinafter) 500, a processing unit 510, a storage unit 530 and an output interface (which will be referred to as an “output I/F” hereinafter) 540.

Input I/F 500 receives an IG switch signal provided from IG switch 88, a plug connection signal provided from coupling determination sensor 180 and a charge determination signal provided from HV-ECU 330, and transmits them to processing unit 510. Processing unit 510 includes a connection determining unit 512 and a relay control unit (1) 514.

Connection determining unit 512 determines whether charge cable 1020 is connected or not, according to the plug connection signal. Connection determining unit 512 may be configured to turn on a connection determination flag when it determines that charge cable 1020 is connected, and to turn off the connection determination flag when it determines that charge cable 1020 is not connected (i.e., is disconnected).

When the connection of charge cable 1020 is determined, relay control unit (1) 514 produces a control signal for turning on relay 308, and transmits the produced control signal to relay 308 via output I/F 540.

Further, when relay control unit (1) 514 receives the charge determination signal indicating the completion of the charging of battery 130, it produces the control signal for turning off relay 308, and transmits the produced control signal to relay 308 via output I/F 540.

Relay control unit (1) 514 may be configured to produce the control signal that turns on relay 308 when the communication determination flag is turned on. When relay 308 is turned on, the activation signal is transmitted via a communication line 334 to HV-ECU 330. When relay 308 is turned off in response to completion of the charging of battery 130, HV-ECU 330 stops after it stops the hybrid devices.

In this embodiment described above, each of connection determining unit 512 and relay control unit (1) 514 is implemented by software and particularly by executing a program stored in storage unit 530 by processing unit 510, i.e., a CPU (Central Processing Unit). However, these may be implemented by hardware. The above program is stored on a recording medium for carrying them on the vehicle.

Storage unit 530 stores various kinds of information, programs, thresholds, maps and the like. When necessary, processing unit 510 reads or stores such data from/in storage unit 530.

HV-ECU 330 includes an input I/F 550, a processing unit 560, a storage unit 570 and an output I/F 580. Input I/F 500 receives an SOC signal provided from battery ECU 340 and the activation signal provided from power supply ECU 320, and transmits them to processing unit 510. Processing unit 560 includes a relay control unit (2) 562, a load control unit 564, a voltage setting unit 566, a converter control unit 568 and a charge completion determining unit 572.

When relay control unit (2) 562 receives the activation signal from power supply ECU 320 via input I/F 550, it produces a control signal turning on relay 350, and transmits the produced control signal to relay 350 via output I/F 580. Further, when relay control unit (2) 562 enters a state in which it does not receive the activation signal from power supply ECU 320, it stops the operations of the hybrid devices, produces the control signal turning off relay 350 and transmits the produced control signal to relay 350 via output I/F 580.

Load control unit 564 executes load control. For example, load control unit 564 produces the load control signal to reduce the operation quantity of cooling pump 142 that operates according to the operation of inverter 140, or to stop the operation of cooling pump 142. Load control unit 564 transmits the produced load control signal to cooling pump 142 via output I/F 580 and charge-time-dedicated communication line 338. Further, load control unit 564 may be configured to produce the load control signal to reduce the operation quantity of cooling fan 342 (i.e., the operation quantity controlled by battery ECU 340), or to stop the operation of cooling fan 342.

Voltage setting unit 566 sets the output voltage of DC-DC converter 250. For example, when voltage setting unit 566 receives the activation signal from communication line 334 via input I/F 550, it sets the output voltage of DC-DC converter 250 to a predetermined voltage lower than the ordinary output voltage.

Converter control unit 568 produces the control signal corresponding to the set voltage, and transmits the produced control signal to DC-DC converter 250 via output I/F 580.

Charge completion determining unit 572 determines whether external charging device 1000 has completed the charging of battery 130 or not, based on the SOC signal provided from battery ECU 340. For example, charge completion determining unit 572 determines whether the quantity of charge of battery 130 is equal to or larger than a predetermined quantity of charge, or not. Further, charge completion determining unit 572 produces the charge determination signal indicating a result of the determination, and transmits the produced charge determination signal to power supply ECU 320 via output I/F 580 and communication line 325.

In this embodiment described above, each of relay control unit (2) 562, load control unit 564, voltage setting unit 566, converter control unit 568 and charge completion determining unit 572 is implemented by software and particularly by executing a program stored in storage unit 570 by processing unit 560, i.e., the CPU. However, these may be implemented by hardware. The above program is stored on a recording medium for carrying them on the vehicle.

Storage unit 570 stores various kinds of information, programs, thresholds, maps and the like. When necessary, processing unit 560 reads or stores such data from/in storage unit 570.

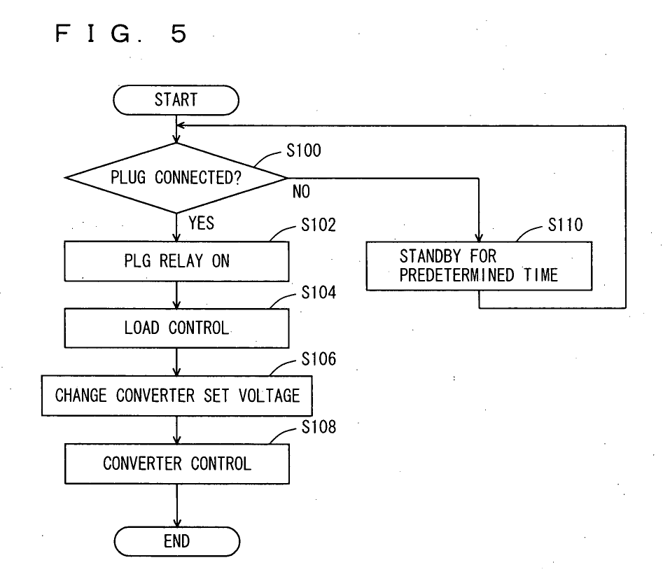

Referring to FIG. 5, description will be given on the control structure of the program executed by control device 300 of the vehicle according to the embodiment. When the program is executed, control device 300 implements the activation control sequence of the electric devices in the state where charge cable 1020 is connected.

In a step (which will be referred to as “S” hereinafter) 100, power supply ECU 320 determines whether plug 1040 of charge cable 1020 is connected to socket 160 or not. More specifically, when power supply ECU 320 receives the plug connection signal from coupling determination sensor 180, it determines that plug 1040 is connected to socket 160. When it is determined plug 1040 is connected to socket 160 (YES in S100), the process proceeds to S 102. Otherwise (NO in S100), the process proceeds to S110.

In S102, power supply ECU 320 turns on relay 308. When relay 308 is turned on, the activation signal is transmitted via communication line 334 to HV-ECU 330.

In S104, HV-ECU 330 implements the load control. In S106, HV-ECU 330 changes the set voltage of DC-DC converter 250 to a predetermined voltage lower than the ordinary output voltage. In S108, HV-ECU 330 controls the output voltage of DC-DC converter 250 to attain the set voltage.

In S110, power supply ECU 320 will be on standby until a predetermined time elapses. More specifically, power supply ECU 320 measures the elapsed time by a timer or the like. Thus, power supply ECU 320 resets a count to an initial value, and then starts to increment the count by a predetermined value. Power supply ECU 320 returns the processing to S100 when the count attains a value corresponding to a predetermined elapsed time. The predetermined elapsed time is not particularly restricted.

Based on the structure and flowchart described above, control device 300 of the vehicle according to the embodiment performs the operation corresponding to the start control sequence as described below.

When the vehicle is at rest and IG switch 88 is off, coupling determination sensor 180 transmits the plug connection signal to power supply ECU 320 of control device 300 when plug 1040 of charge cable 1020 is connected to socket 160. When power supply ECU 320 receives the plug connection signal, it determines that plug 1040 is connected to socket 160 (YES in S100).

At this time, power supply ECU 320 turns on relay 308. In response to the turn-on of relay 308, the activation signal is transmitted to HV-ECU 330 via communication line 334. Further, the activation signal is transmitted to navigation system 94 via communication line 328. Navigation system 94 is activated by receiving the power from battery 132 in response to the reception of the activation signal. At this time, navigation system 94 displays the state of charge of battery 132 charged by external charging device 1000.

HV-ECU 330 is activated in response to reception of the activation signal, and turns on relay 350 to execute the load control corresponding to the external charging (S104). Further, HV-ECU 330 changes the set voltage of DC-DC converter 250 to a voltage lower than the ordinary output voltage (S106), and controls DC-DC converter 250 to output the voltage equal to the voltage thus set (S108). When the plug connection signal is not received (NO in S100), HV-ECU 330 will be on standby until a predetermined time elapses (S110).

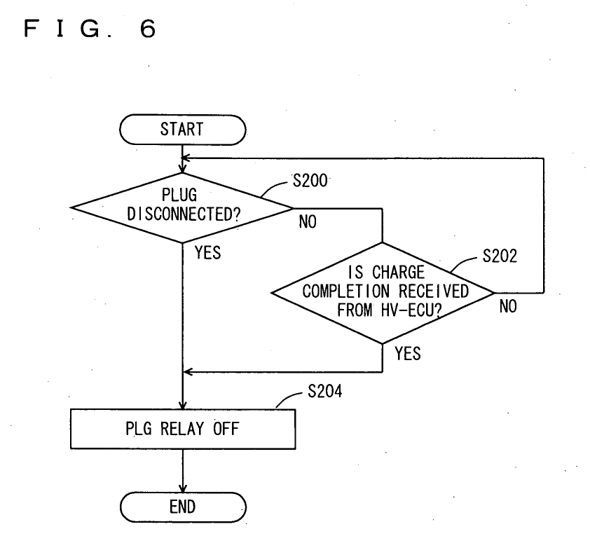

Referring to FIG. 6, description will be given on the control structure of the program executed by control device 300 of the vehicle according to the embodiment. By executing the program, control device 300 implements an end control sequence of the electric devices at the time of disconnection of charge cable 1020.

In S200, power supply ECU 320 determines whether plug 1040 of charge cable 1020 is disconnected from socket 160 or not. More specifically, when power supply ECU 320 enters the state in which it does not receive the plug connection signal from coupling determination sensor 180, power supply ECU 320 determines that plug 1040 is disconnected. When power supply ECU 320 keeps the state in which it receives the plug signal, power supply ECU 320 determines that plug 1040 is disconnected. When power supply ECU 320 determines that plug 1040 is disconnected from socket 160 (YES in S200), the process proceeds to S204. Otherwise (NO in S200), the process proceeds to S202.

In S202, power supply ECU 320 determines whether it receives the charge determination signal indicating the completion of charging of battery 130 from HV-ECU 330 or not. When power supply ECU 320 receives the charge determination signal indicating the completion of charging (YES in S202), the process proceeds to step S204. Otherwise (NO in S202), the process returns to S200.

In S204, power supply ECU 320 turns off relay 308. This stops the electric devices that were activated when plug 1040 was connected to socket 160 and relay 308 was turned on. More specifically, when power supply ECU 320 turns on relay 308, HV-ECU 330 stops the operations of the hybrid devices, and then turns off relay 350 to stop the operation of HV-ECU 330 itself.

Based on the structure and flowchart described above, control device 300 of the vehicle according to the embodiment performs the operation corresponding to the end control sequence as described below.

It is assumed that plug 1040 of charge cable 1020 is connected to socket 160.

When the state in which plug 1040 is connected to socket 160 is kept (NO in S200) and HV-ECU 330 issues the charge determination signal indicating the completion of charging of battery 130 (YES in S202), relay 308 is turned off (S204). When plug 1040 is disconnected from socket 160 (YES in S200), relay 308 is turned off (S204).

When relay 308 is turned off, HV-ECU 330 stops relay 350 to stop the operation of HV-ECU 330 itself after it stops the operations of the hybrid devices.

In the control device for the vehicle according to the embodiment, as described above, when the connection of the plug of the charge cable is detected, the power supply ECU transmits the activation signal via the communication line to perform the activation control on the electric device group related to the charging by the external charging device. Thereby, the control device can start only the electric devices related to the charging while keeping the electric devices not related to the charging at rest. Therefore, wasting of the electric power can be suppressed. Consequently, it is possible to reduce the power consumption in the external charging device or the battery, and further to reduce the charge time required for charging the power storage device by the external charging device. Since it is not necessary to employ the power supply device controlling the supplied power for each of the electric devices related to the charging, the space for mounting the electric devices is not restricted. Accordingly, it is possible to provide the control device and the control method for the vehicle that ensure the mounting space, selectively operate the electric devices related to the charging of the power storage device when the external charging is performed, and thereby reduce the power consumption during the external charging and the charge time of the power storage device.

Further, the activation signal is provided to the electric devices (the navigation system in this embodiment) via the OR circuit from the communication line corresponding to the power supply system of the ACC and the communication line corresponding to the power supply system dedicated to the charge operation. Thereby, in addition to the ordinary time when the vehicle is activated, the electric devices can be activated when the external charging device charges the power storage device.

Further, the electric devices related to the charging by the external charging device are connected together by the charge-time-dedicated communication line. During the external charging, the electric devices related to the charging are active so that it is possible to suppress the occurrence of the communication error due to no response in the communication operation. Accordingly, it is not necessary to set an error mask or the like for avoiding the communication error for each of the electric devices.

When the connection of the plug of the charge cable is detected, the load control is performed on the electric devices to reduce the load quantity of the electric load during the operation of the electric devices. Thereby, the power consumption of the external charging device or the battery can be reduced during the external charging.

When the connection of the plug of the charge cable is detected, the control is performed to lower the output voltage of the DC-DC converter so that the power consumption of the resistive load or the like such as a heater can be reduced.

Further, when the plug is disconnected from the socket or the charging of the battery on the high voltage side is completed, the electric devices related to the charging in the external charging operation are stopped so that the power consumption of the battery can be small.

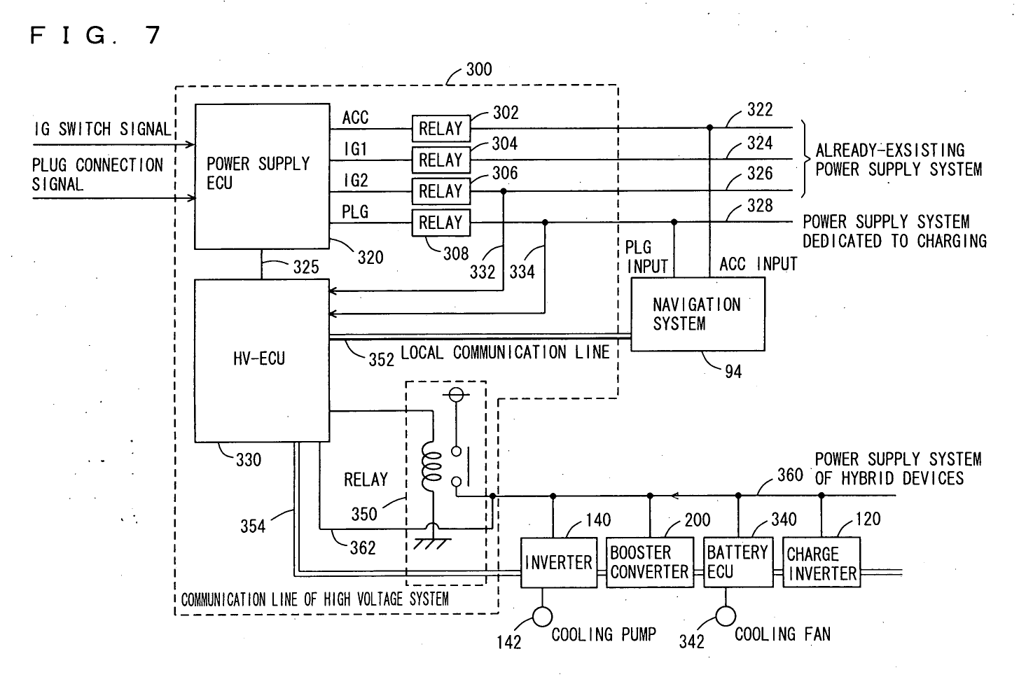

The control device for the vehicle according to the embodiment is not particularly restricted to the structure shown in FIG. 3. For example, as shown in FIG. 7, control device 300 may not employ communication lines 336 and 338 in FIG. 3, and alternatively may employ a local communication line 352 connecting HV-ECU 330 to the navigation system as well as a communication line 354 that is arranged independently of local communication line 352 for connecting HV-ECU 330 to the hybrid devices. This structure can achieve substantially the same effect as the structure of control device 300 shown in FIG. 3 by the substantially same operations.

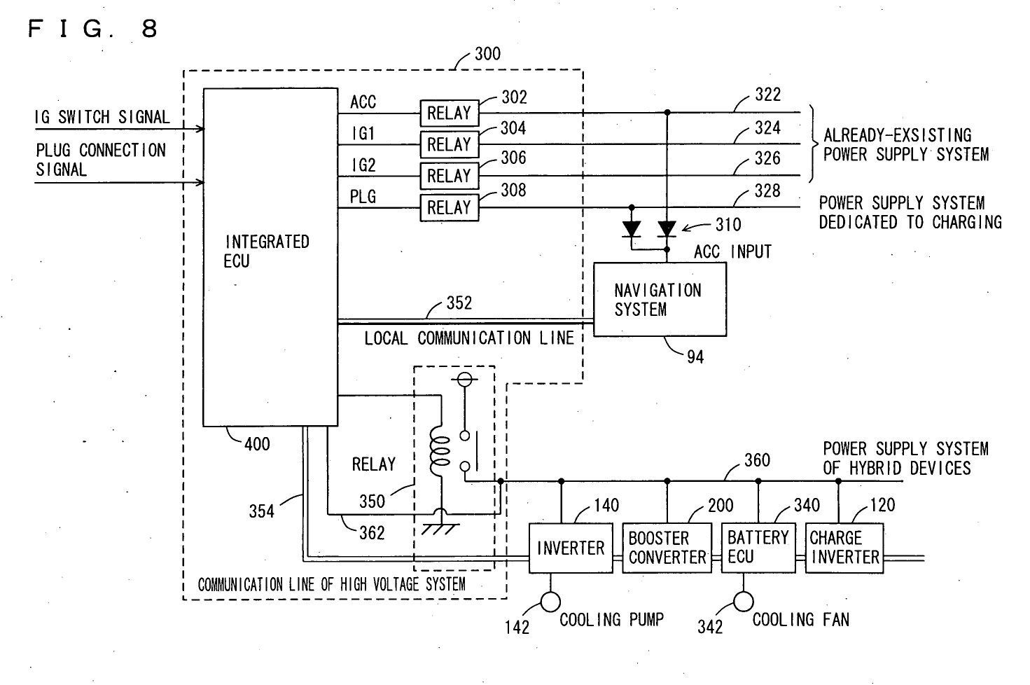

Alternatively, control device 300 may include, e.g., an ECU 400 having the functions of power supply ECU 320 and HV-ECU 330 in an integrated function as shown in FIG. 8 instead of power supply ECU 320 and HV-ECU 330 in FIG. 3. Further, instead of communication lines 336 and 338 in FIG. 3, it may include local communication line 352 connecting an integrated ECU 400 to the navigation system as well as communication line 354 arranged independent of local communication line 352 for connecting integrated ECU 400 to the hybrid devices. This structure can achieve substantially the same effect as the structure of control device 300 shown in FIG. 3 by the substantially same operations.

In this embodiment described above, when the plug of the charge cable is connected to the socket, the plurality of electric devices mounted on the vehicle are controlled to activate the group of the electric devices related to the external charging. However, the control device may be configured to activate the electric devices related to the charging in response to the detection of a change in position of a member that is operated in charging by the external charging device. For example, when a cover member is arranged for the socket, an electric device group related to the external charging in the plurality of electric devices mounted on the vehicle may be activated when the cover member opens.

<Second Embodiment>

The control device for the vehicle according to the second embodiment will be described below. The control device for the vehicle according to the embodiment differs from that according to the first embodiment already described in the structure of control device 300. Other structures are the same as those of the vehicle equipped with the control device according to the embodiment already described. The same portions bear the same reference numbers and achieve the same functions. Therefore, description thereof is not repeated.

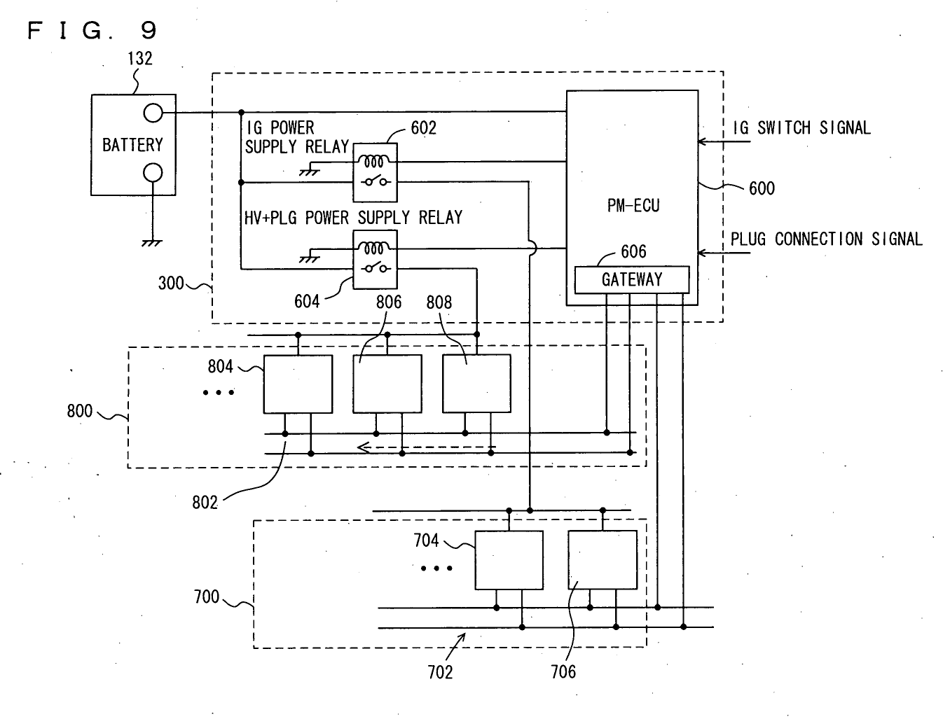

As shown in FIG. 9, control device 300 of this embodiment includes a PM-(Power Management-) ECU 600, an IG power supply relay 602 and an HV+PLG power supply relay 604. The vehicle is equipped with a plurality of electric devices, which include an electric device group 700 that is activated in response to reception of the activation signal transmitted according to an activation operation, e.g., on IG switch 88 of the vehicle, and an electric device group 800 related to the charging by external charging device 1000. The plurality of electric devices may be configured to include at least one electric device that belongs to both electric device groups 700 and 800.

PM-ECU 600 receives the IG switch signal from IG switch 88, and also receives the plug connection signal from coupling determination sensor 180.

PM-ECU 600 is connected to IG power supply relay 602 corresponding to the power supply system of the IG and a HV+PLG power supply relay 604 corresponding to the power supply systems of the hybrid devices and the PLG. PM-ECU 600 may be configured to connect further to a relay (not shown) corresponding to the power supply system of the ACC.

For example, when the driver performs, on IG switch 88, an operation corresponding to the activation request for the electric device connected to the power supply system of the IG, PM-ECU 600 receives the IG switch signal from IG switch 88, and thereby PM-ECU 600 transmits the control signal to turn on IG power supply relay 602 and HV+PLG power supply relay 604.

In response to the reception of the on signal from PM-ECU 600, the state of power supply from battery 132 to the electric devices of the IG power supply system is changed by IG power supply relay 602 from a non-supply state to a supply state. Therefore, when IG power supply relay 602 is turned on, the power is supplied from battery 132 to electric devices 704 and 706 connected to electric device group 700 connected to the power supply system of the IG so that electric devices 704 and 706 are activated.

Further, HV+PLG power supply relay 604 changes collectively the states of power supply from battery 132 on the lower voltage side to respective electric devices 804, 806 and 808 of electric device group 800 to the supply state or the non-supply state. Electric devices 804, 806 and 808 include the hybrid devices (i.e., the electric devices related to the operation of MG1 and MG2) as well as the electric devices (e.g., navigation system 94) connected to the power supply system of the PLG. Therefore, when HV+PLG power supply relay 604 is turned on, battery 132 supplies the power to the hybrid devices and the electric devices connected to the PLG power supply system to activate them.

When the position change of the member that is operated for the charging by external charging device 1000 is detected, PM-ECU 600 controls HV+PLG power supply relay 604 to change the non-supply state to the supply state.

In this embodiment, when PM-ECU 600 receives the plug connection signal from coupling determination sensor 180, it transmits the control signal to turn on HV+PLG power supply relay 604.

PM-ECU 600 is connected to electric devices 704 and 706 of electric device group 700 via a communication bus 702. Further, PM-ECU 600 is connected to electric devices 804, 806 and 808 of electric device group 800 via a communication bus 802.

PM-ECU 600 has a gateway 606 connected to both communication buses 702 and 802, and inhibits the data transfer between communication buses 702 and 802 when it receives the plug connection signal.

When PM-ECU 600 receives the plug connection signal from coupling determination sensor 180, it performs the load control on the hybrid devices. The control manner of the load control is substantially the same as that already described in the first embodiment, and therefore description thereof is not repeated.

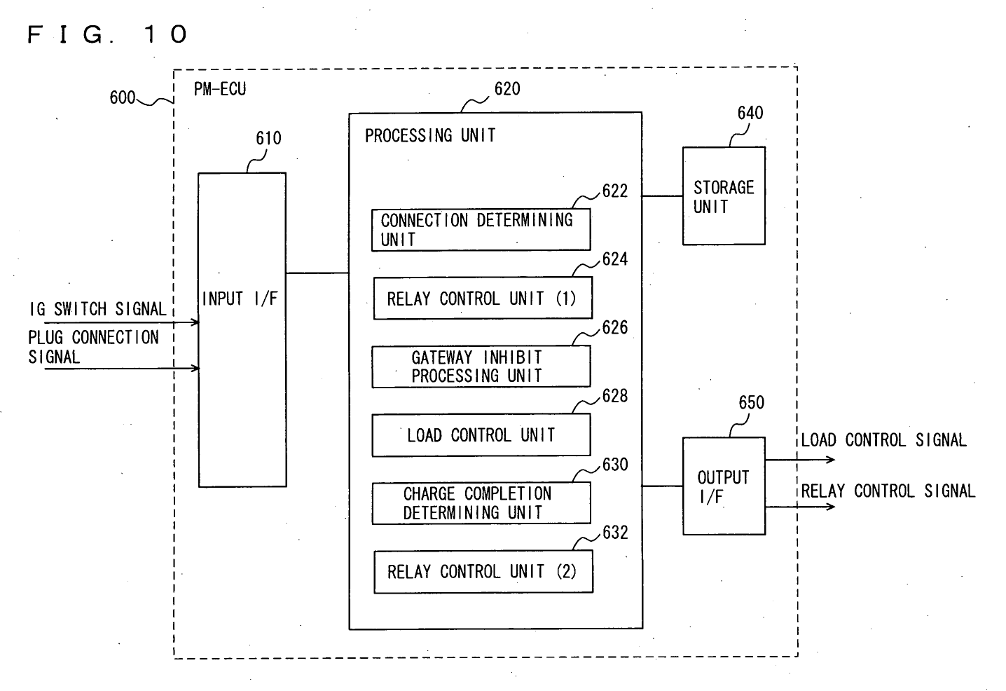

FIG. 10 is a functional block diagram of control device 300 of the vehicle according to this embodiment. PM-ECU 600 includes an input I/F 610, a processing unit 620, a storage unit 640 and an output I/F 650.

Input I/F 610 receives the IG switch signal provided from IG switch 88 and the plug control signal provided from coupling determination sensor 180, and transmits them to processing unit 620.

Processing unit 620 includes a connection determining unit 622, a relay control unit (1) 624, a gateway inhibit processing unit 626, a load control unit 628, a charge completion determining unit 630 and a relay control unit (2) 632.

Connection determining unit 622 determines whether charge cable 1020 is connected or not, based on the plug connection signal. For example, connection determining unit 622 may be configured to turn on a connection determination flag when it detects the connection of charge cable 1020, and to turn off the connection determination flag when it detects the disconnection of charge cable 1020.

When the connection of charge cable 1020 is detected, relay control unit (1) 624 produces the control signal turning on HV+PLG power supply relay 604, and transmits the produced control signal to HV+PLG power supply relay 604 via output I/F 650.

Relay control unit (1) 624 may be configured to produce the control signal turning on HV+PLG power supply relay 604 when the connection determination flag is turned on.

When the connection of charge cable 1020 is detected, gateway inhibit processing unit 626 inhibits the data transfer between communication buses 702 and 802 in gateway 606. Gateway inhibit processing unit 626 may be configured to inhibit the data transfer between communication buses 702 and 802 when the connection determination flag is on.

Load control unit 628 implements the load control when the connection of charge cable 102 is detected.

Charge completion determining unit 630 determines whether the charging of battery 130 by external charging device 1000 is completed or not. For example, charge completion determining unit 630 determines whether the quantity of charge of battery 130 is equal to or larger than a predetermined quantity of charge or not. For example, charge completion determining unit 630 may be configured to determine whether the quantity of charge of battery 130 is equal to or larger than the predetermined quantity of charge or not, based on information that is received from the battery ECU (not shown) and relates to the quantity of charge of battery 130. Alternatively, the SOC of battery 130 may be estimated using an open-circuit voltage of battery 130, an integrated value of the charge/discharge current or the like, and charge completion determining unit 630 may determine whether the quantity of charge of battery 130 is equal to or larger than the predetermined quantity of charge, or not.

For example, charge completion determining unit 630 may be configured to turn on the completion determination flag when it determines that the charging of battery 130 is completed.

When charge completion determining unit 630 determines that the charging of battery 130 is completed, relay control unit (2) 632 produces the control signal that turns off HV+PLG power supply relay 604, and transmits the produced control signal to HV+PLG power supply relay 604 via output I/F 650.

Relay control unit (2) 632 may be configured to produce the control signal turning off HV+PLG power supply relay 604, e.g., when the completion determination flag is turned on.

In this embodiment described above, each of connection determining unit 622, relay control unit (1) 624, gateway inhibit processing unit 626, load control unit 628, charge completion determining unit 630 and relay control unit (2) 632 is implemented by software and particularly by executing a program stored in storage unit 640 by processing unit 620 that is the CPU. However, these may be implemented by hardware. The above program is stored on a recording medium for carrying them on the vehicle.

Storage unit 640 stores various kinds of information, programs, thresholds, maps and the like. When necessary, processing unit 620 reads or stores such data from/in storage unit 640.

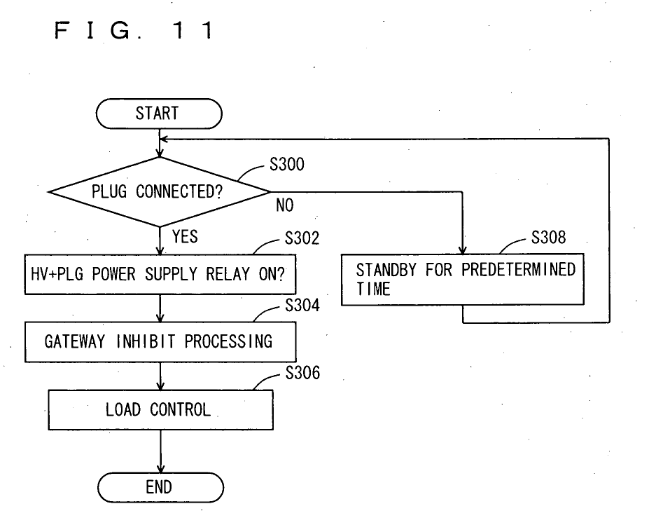

Referring to FIG. 11, description will be given on the control structure of the programs executed by PM-ECU 600 that is the control device for the vehicle according to the embodiment.

In S300, PM-ECU 600 determines whether plug 1040 of charge cable 1020 is connected to socket 160 or not. More specifically, when PM-ECU 600 receives the plug connection signal from coupling determination sensor 180, it determines that plug 1040 is connected to socket 160. When PM-ECU 600 determines that plug 1040 is connected to socket 160 (YES in S300), the process proceeds to 5302. Otherwise (NO in S300), the process proceeds to S308.

In 5302, PM-ECU 600 turns on HV+PLG power supply relay 604. In S304, PM-ECU 600 executes the gateway inhibit processing. Thus, PM-ECU 600 inhibits the data transfer between communication buses 702 and 802.

In S306, PM-ECU 600 implements the load control. In 5308, PM-ECU 600 keeps the standby state until a predetermined time elapses. More specifically, PM-ECU 600 measures the elapsed time by a timer or the like. Thus, PM-ECU 600 resets the count to an initial value, and then starts to increment the count by a predetermined value. PM-ECU 600 returns the processing to S300 when the count attains a value corresponding to a predetermined elapsed time. The predetermined elapsed time is not particularly restricted.

Based on the structure and flowchart described above, control device 300 of the vehicle according to the embodiment performs the operation corresponding to the start control sequence as described below.

In the state where the vehicle is at rest and IG switch 88 is off, coupling determination sensor 180 transmits the plug connection signal to PM-ECU 600 when plug 1040 of charge cable 1020 is connected to socket 160. When PM-ECU 600 receives the plug connection signal, it determines that plug 1040 is connected to socket 160 (YES in S300).

At this time, PM-ECU 600 turns on HV+PLG power supply relay 604 (S302). In response to the turn-on of HV+PLG power supply relay 604, the activation signal is transmitted to the electric devices of electric device group 800 via communication bus 702. For example, navigation system 94 is activated by receiving the power from battery 132 in response to the reception of the activation signal. At this time, navigation system 94 displays the state of charge of battery 132 charged by external charging device 1000.

After PM-ECU 600 turns on HV+PLG power supply relay 604, it inhibits the data transfer at gateway 606 between communication buses 702 and 802 (S304). Thereby, the activation of the electric devices not related to the charging is suppressed.

PM-ECU 600 implements the load control corresponding to the external charging (S306). When the plug connection signal is not received (NO in S300), it will be on standby until a predetermined time elapses (S308).

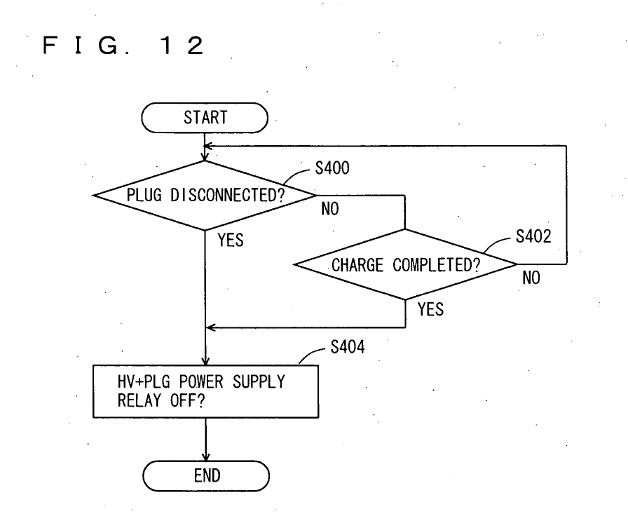

Referring to FIG. 12, description will be given on the control structure of the program executed by control device 300 of the vehicle according to the embodiment. By executing the program, control device 300 implements the end control sequence of the electric devices at the time of disconnection of charge cable 1020.

In S400, PM-ECU 600 determines whether plug 1040 of charge cable 1020 is disconnected from socket 160 or not. More specifically, when PM-ECU 600 enters the state in which it does not receive the plug connection signal from coupling determination sensor 180, PM-ECU 600 determines that plug 1040 is disconnected. When the state in which PM-ECU 600 receives the plug connection signal is kept, it determines that plug 1040 is not disconnected. When PM-ECU 600 determines that plug 1040 is disconnected from socket 160 (YES in S400), the process proceeds to S404. Otherwise (NO in S400), the process returns to S400.

In S402, PM-ECU 600 determines whether the charging of battery 130 is completed or not. When it determines that the charging is completed (YES in S402), the process proceeds to S404. Otherwise (NO in S402), the process returns to S400.

In S404, PM-ECU 600 turns off HV+PLG power supply relay 604. At this time, PM-ECU 600 turns off the electric devices that were activated when plug 1040 was connected to socket 160 and HV+PLG power supply relay 604 is turned on.

Based on the structure and flowchart described above, control device 300 of the vehicle according to the embodiment performs the operation corresponding to the end control sequence as described below.

It is assumed that plug 1040 of charge cable 1020 is connected to socket 160. When the state in which plug 1040 is connected to socket 160 is kept (NO in S400) and it is determined that the charging of battery 130 is completed (YES in S402), HV+PLG power supply relay 604 is turned off (S404). When plug 1040 is disconnected from socket 160 (YES in S400), HV+PLG power supply relay 604 is turned off (S404).

In addition to the effect offered by the control device for the vehicle according to the first embodiment, the control device for the vehicle according to the second embodiment can operate such that the power supply states of the group of electric devices related to the charging by the external charging device are collectively set by the HV+PLG power supply relay to the state for supplying the power and the state not supplying it, as described above, Therefore, as compared with the case where an independent relay of the like is arranged for each electric device, it is possible to suppress the increase in mass, and it is possible to prevent deterioration in mountability of other parts on the vehicle that may be caused by provision of the plurality of relays. Accordingly, the space for mounting the electric devices can be ensured.

In addition to the load control, the second embodiment may be configured to change the set voltage of the DC-DC converter, as is done in the control device for the vehicle of the first embodiment already described. Although the present invention has been described and illustrated in detail, it is clearly understood that the same is by way of illustration and example only and is not to be taken by way of limitation, the scope of the present invention being interpreted by the terms of the appended claims.

1. A control device for a vehicle having at least a rotating electric machine as a drive source, said vehicle including a plurality of electric devices, a power storage device supplying an electric power to said rotating electric machine and said plurality of electric devices, and a connection unit connecting a charge cable of an external charging device charging said power storage device, and
said control device comprising:
a first control unit transmitting an activation signal corresponding to an activating operation of said vehicle via a first communication line connected to a predetermined first electric device group in said plurality of electric devices, and performing activation control on said first electric device group; and
a second control unit transmitting an activation signal via a second communication line connected to a predetermined second electric device group, that is included in said plurality of electric devices and related to the charging by said external charging device, and performing activation control on said second electric device group.

2. The control device for the vehicle according to claim 1, further comprising:
a detecting unit detecting a position change of a member operated in charging by said external charging device, wherein
said second control member performs the activation control on said second electric device group when the position change of said member is detected.

3. The control device for the vehicle according to claim 2, wherein
said detecting unit detects the connection of said charge cable to said connection unit.

4. The control device for the vehicle according to claim 1, wherein
said second electric device group includes an electric device connected to said first and second communication lines, and
said electric device is activated based on at least one of the activation signals transmitted via respective said first and second communication lines.

5. The control device for the vehicle according to claim 1, wherein
said second electric device group includes first and second electric devices, and
a local communication line connects said first and second electric devices together.

6. The control device for the vehicle according to claim 1, wherein
said power storage device includes a power storage device on a high voltage side and a power storage device on a low voltage side,
said second electric device group includes an electric device operating in connection with said power storage device on the high voltage side, and
said control device further comprises a load control unit controlling said electric device to reduce a load quantity of the electric load during operation of said electric device when the connection of said charge cable is detected.

7. The control device for the vehicle according to claim 6, wherein
said second electric device group includes a converter charging said power storage device on the low voltage side with the electric power of said power storage device on the high voltage side, and
said load control unit controls said converter to lower an output voltage during the charging of said power storage device on the low voltage side by said converter when the connection of said charge cable is detected.

8. The control device for the vehicle according to claim 6, wherein
said load control unit controls said electric device to stop a function not related to the charging when said electric device operates.

9. The control device for the vehicle according to claim 1, wherein
said power storage device includes a power storage device on a high voltage side and a power storage device on a low voltage side,
the electric devices of said second electric device group operate by receiving the electric power from said power storage device on the low voltage side during said activation control, and
said control device comprises:
a relay changing collectively a state of power supply from said power storage device on the low voltage side to said second electric device group to one of a supply state and a non-supply state;
a position change detecting unit detecting a position change of a member operated in charging by said external charging device; and
an activating operation detecting unit detecting an activating operation of said vehicle, and
said control device controls said relay to change said state of power supply to the supply state when at least one of the position change of said member and the activation operation of said vehicle is detected.

10. The control device for the vehicle according to claim 9, wherein
the electric device of said first electric device group operates by receiving the electric power from said power storage device on the low voltage side during said activation control,
said control device further comprises a relay changing collectively a state of power supply from said power storage device on the low voltage side to said first electric device group to one of a supply state and a non-supply state, and
said control device controls said relay to change said state of power supply to the supply state when the activation operation of said vehicle is detected.

11. A control method for a vehicle having at least a rotating electric machine as a drive source, said vehicle including a plurality of electric devices, a power storage device supplying an electric power to said rotating electric machine and said plurality of electric devices, and a connection unit connecting a charge cable of an external charging device charging said power storage device, and
said control method comprising:
a first control step of transmitting an activation signal corresponding to an activating operation of said vehicle via a first communication line connected to a predetermined first electric device group in said plurality of electric devices, and performing activation control on said first electric device group; and
a second control step of transmitting an activation signal via a second communication line connected to a predetermined second electric device group, that is included in said plurality of electric devices and related to the charging by said external charging device, and performing activation control on said second electric device group.

12. The control method for the vehicle according to claim 11, further comprising:
a detecting step of detecting a position change of a member operated in charging by said external charging device, wherein
said second control step performs the activation control on said second electric device group when the position change of said member is detected.

13. The control method for the vehicle according to claim 12, wherein
said detecting step detects the connection of said charge cable to said connection unit.

14. The control method for the vehicle according to claim 11, wherein
said second electric device group includes an electric device connected to said first and second communication lines, and
said electric device is activated based on at least one of the activation signals transmitted via respective said first and second communication lines.

15. The control method for the vehicle according to claim 11, wherein
said second electric device group includes first and second electric devices, and
a local communication line connects said first and second electric devices together.

16. The control method for the vehicle according to claim 11, wherein
said power storage device includes a power storage device on a high voltage side and a power storage device on a low voltage side,
said second electric device group includes an electric device operating in connection with said power storage device on the high voltage side, and
said control method further comprises a load control step of controlling said electric device to reduce a load quantity of the electric load during operation of said electric device when the connection of said charge cable is detected.

17. The control method for the vehicle according to claim 16, wherein
said second electric device group includes a converter charging said power storage device on the low voltage side with the electric power of said power storage device on the high voltage side, and
said load control step controls said converter to lower an output voltage during the charging of said power storage device on the low voltage side by said converter when the connection of said charge cable is detected.

18. The control method for the vehicle according to claim 16, wherein
said load control step controls said electric device to stop a function not related to the charging when said electric device operates.

19. The control method for the vehicle according to claim 11, wherein
said power storage device includes a power storage device on a high voltage side and a power storage device on a low voltage side,
said power storage device includes a power storage device on a high voltage side and a power storage device on a low voltage side,
the electric device of said second electric device group operates by receiving the electric power from said power storage device on the low voltage side during said activation control,
a relay changing collectively a state of power supply from said power storage device on the low voltage side to said second electric device group to one of a supply state and a non-supply state is arranged between said power storage device on the low voltage side and said second electric device group, and
said control method further comprises:
a position change detecting step of detecting a position change of a member operated in charging by said external charging device;
an activating operation detecting step of detecting an activating operation of said vehicle; and
a step of controlling said relay to change said state of power supply to the supply state when at least one of the position change of said member and the activation operation of said vehicle is detected.

20. The control method for the vehicle according to claim 19, wherein
the electric device of said first electric device group operates by receiving the electric power from said power storage device on the low voltage side during said activation control,
a relay changing collectively a state of power supply from said power storage device on the low voltage side to said first electric device group to one of a supply state and a non-supply state is arranged between said power storage device on the low voltage side and said first electric device group, and
said control method further comprises a step of controlling said relay to change said state of power supply to the supply state when the activation operation of said vehicle is detected.
